(19) United States
(12) Patent Application Publication
(10) Pub. No.: US 2013/0202267 A1
(43) Pub. Date: Aug. 8, 2013

(54) INTERACTIVE VIDEO REFLECTION SHOPPING AID

(71) Applicant: Sergey Khromov, Sunny Isles, FL (US)

(72) Inventor: Sergey Khromov, Sunny Isles, FL (US)

(21) Appl. No.: 13/368,320

(22) Filed: Feb. 7, 2012

(51) Int. Cl. H04N 5/91; H04N 7/15; H04N 7/18

(52) U.S. Cl. 386/225; 386/E05.002; 348/E07.085; 348/E07.083

(57) ABSTRACT

An internet enabled electronic display with integrated cameras, microphone, scanner and other optional features that can connect a shopper to additional information about the products and to others not located in the same place. The device provides a shopper the ability to view herself in real-time on the display performing as a virtual mirror as well as recording still and video for later playback or transmission. The device interacts with others directly or via social network where feedback from others is presented the shopper.

### BACKGROUND OF THE INVENTION

1. Field of the Invention

The present invention relates to interactive electronic shopping aid devices, and more particularly, to device that captures and displays images and other information and includes internet connectivity.

2. Description of the Related Art

Several designs for electronic shopping aids have been designed in the past. None of them, however, is known to include a large format touch screen display that captures images from an integrated camera and selectively displays both live and recorded images to both the user and a pre-selected group of others that also includes some combination of additional features including video conferencing, text conferencing, comparison images and relevant product data in a unified, convenient form factor.

Applicant believes that the closest reference corresponds to U.S. Pat. No. 8,036,416 issued to Matsumoto. However, it differs from the present invention because Matsumoto device and method utilize a mirror and a display near the mirror to display alternate synthesized images synchronized to the actual movements of a person trying on clothes. Whereas, the present invention does not necessarily rely on image manipulation to augment the real-time appearance of the user.

The present invention also improves on the ability to interact with others authorized by the user of the device to unify the shopping experience across time and space while also providing enhanced information content to the user.

U.S. Pat. No. 7,953,648 issued to Vock has some relevance to the present invention. However, the Vock device differs from the present invention because Vock relies on synthesized images and fails to provide sufficient interactive features and real-time product data information relevant to an immediate sale of clothing.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a near life sized, real-time image of a person trying on clothes at a retail store while having the ability to interact with others remotely situated to participate in the clothes shopping experience.

It is another object of this invention to provide a device and system that can streamline the clothes shopping experience by allowing a user of the device to communicate to one or more others by multiple media forms including video, audio, still images, text messaging and/or other visual information displays.

It is still another object of the present invention to provide a device that assists a shopper in selecting the most appropriate purchase by allowing the shopper to view themselves actually wearing a then available version of the garment and also providing other relevant information such as alternate styles, colors and sizes that are not necessarily located in the same place as the shopper.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of a version of the device and a shopper (shown in broken lines).

FIG. 2 shows an elevation view of a sample of the contents of a display.

### DETAILED DESCRIPTION OF THE PREFERRED EMBODIMENT

Generally, a principal version of the device can be characterized as being comprised of a large format, touch screen display with integrated image and audio sensors, a computer processor with memory storage and internet connectivity and other input devices. Its most basic features allow the image sensors to capture audio, still images and video for immediate rendering on the device, recording and transmission via the internet (or other transmission means and protocols). Further, the device can interact with internet services to communicate with others, send and receive audio and/or image data and a wide range of other information that can be displayed or heard, as appropriate. More specifically, the primary and optional features of the various versions of the device can fairly be described as shown in the examples below.

Referring now to the drawings, where the present invention is generally referred to with numeral 10, it can be observed that it basically includes frame assembly 12 and a display assembly 14. The frame assembly 12 surrounds and frames the display assembly 14 and also provides a structure onto which the various input, output, control and computer processing components may be mounted.

The frame assembly is shown to be comprised of some optional and required elements shown to be a camera 16, a camera 18, a light 20, a microphone 22, a scanner 24, an input device 26, a support 28, a control panel 30.

The display assembly 14 further includes some optional and required features that may include a display 32, a first inset 34, buttons 36, a ticker 38, a second inset 40, a third inset 42 and a reflection 44. These and other features may or may not also be present.

For contextual and explanatory purposes a sample shopper identified as person “P” is also shown in broken lines with a tag “T” that is attached to and associated with the clothing article that the person P is trying on in anticipation of purchasing the article.

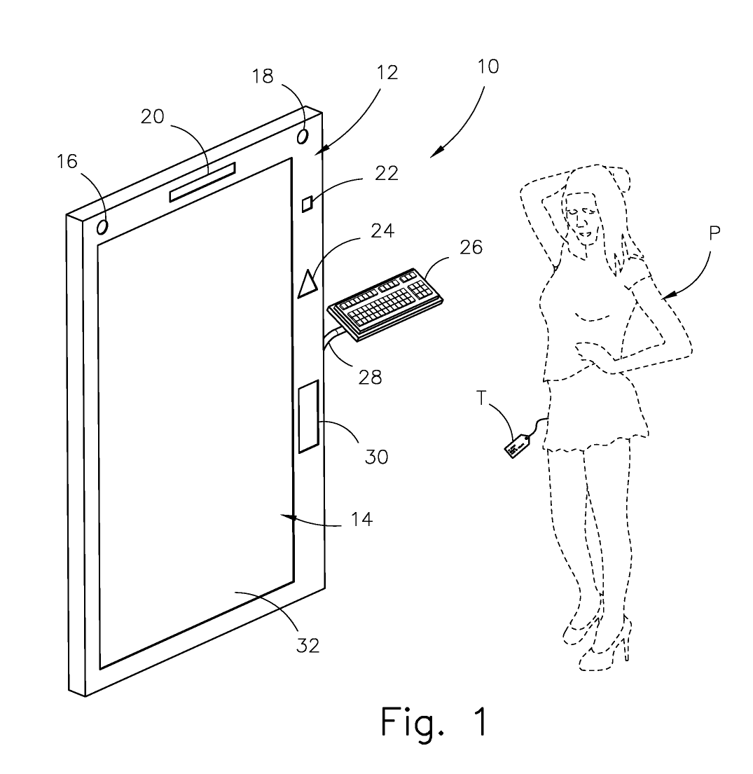

Now, looking more closely at FIG. 1, it depicts a person P who is trying on an article of clothing having a tag T affixed to that article. In a preferred environment the invention is erected by hanging on a wall or other support structure in or near a dressing room in a clothing store. Other support structures may include, for example, the end of a clothing rack, a support stand, a door or suspended from a ceiling member.

In alternate applications of the device may be well suited to use inside a private home's dressing room or bedroom, a tailor's shop or any other location that a person may try on clothes for inspection or review. Generally, it is expected that a private or semi-private location where a person can try on an article of clothing and model it either for themselves or others may be suitable for using the device.

Importantly, when the invention is erected there should be sufficient space in front of the device for a person to stand and move while remaining in front of the device and also having access to the controls of the device and still be able to view the content displayed on the device without undue strain or other discomfort.

A primary feature the device is provided by at least one image sensing device represented by a first camera 16 and an optional second camera 18. Generally, at least one image sensor is directed at approximately in front of the device so that the image sensor may receive an image of a shopper standing in front of the device and display that image onto the display 32. In this manner the device results in a visual display similar to that of a mirror. In other words, when someone stands in front of the device a camera takes real-time images of that person and displays an image substantially similar to what a reflection of that person may look like. In an optional variation, the image may be flipped from right to left about the sagittal plane.

Generally on one image sensor, such as camera 16 or camera 18 is necessary for image capture. In an important variation both camera 16 and camera 18 are present to provide a stereoscopic image for enhanced rendering on three dimensional capable displays, as are becoming more common. Image sensors may be located at any place about the frame assembly 12. The inclusion of alternately located image sensors may be useful for gaining views from various angles. For example, when trying on pants it may be preferable to have the image sensor oriented lower on the frame assembly 12. Likewise, having image sensors on the left and/or right side of the frame assembly 12 may be preferred for improved video rendering or other simultaneous multiple image captures for enhanced display realism.

Still referring to FIG. 1, optionally a light 20 is provided to improve the view, image sensor performance and/or color integrity. For example, if a store has fluorescent lighting an article of clothing may appear to have a different hue than if viewed in natural sunlight. If present, the light 20 is preferably aimed to provide better lighting for the image sensors to capture more realistic images.

In an important version of the device a microphone 22 is present that is capable of capturing the voice of a user of the device. The microphone 22 may be used as an element of a two way communication device so that the shopper can speak with another person remotely. This feature can be offered to allow the shopper to audibly converse with friends, sales associates and customer service representatives. Speakers (not shown in the drawings) are also preferably present and are integrated into the frame assembly 12.

A scanner 24 is preferably present on the device and provides another means of data input. By way of example, the scanner 24 can be any or all of a barcode scanner, radio frequency identification (RFID), image reader, magnetic stripe reader or other available means of alternate data acquisition means commonly available.

The scanner 24 can be used to, for example, read the unique identifying code on a garment's tag T so that information specific to that garment may be utilized. With the garment identified the store selling the garment can gather data such as how frequently a particular style, color, size or version of a garment has generated shopper interest. This could be used for future stock shipments, measuring trends and other commercially interesting uses.

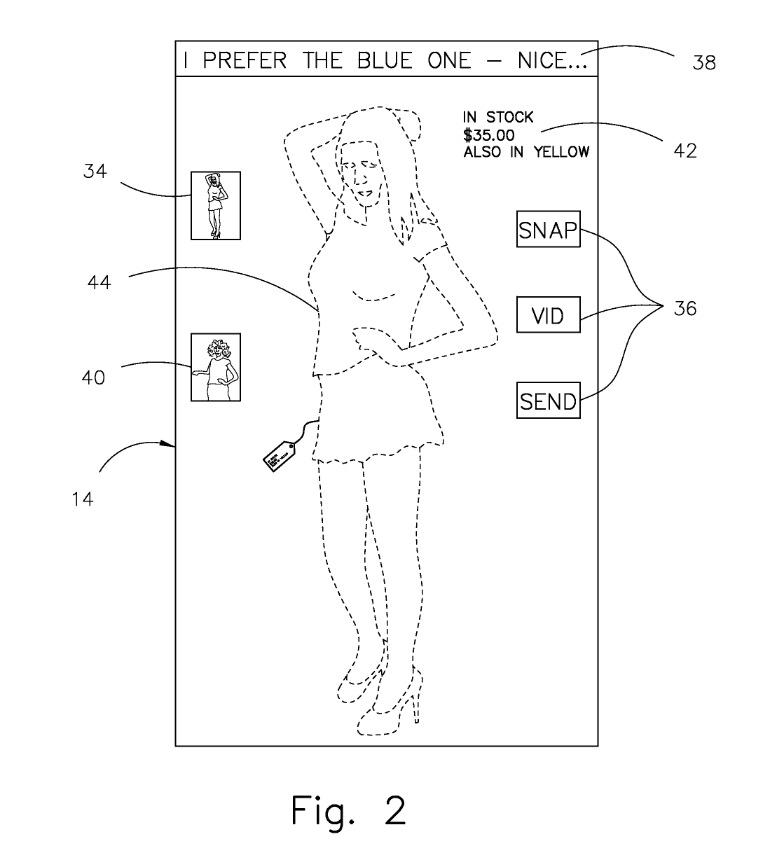

The specific garment information can also acutely assist the shopper by allowing display of relevant information on the display assembly 14. As shown in FIG. 2 at the third inset 42 the availability status, price, alternate products or other information that the retailer may desire to show the shopper to induce a sale by providing additional information to the shopper and enhancing the shopping experience.

The shopper can control the device by using an input device 26, touching the surface of the display 32, a control panel 30, voice control with the microphone 22 or an external device such as remote control that may be embodied as a phone, tablet or other personal, handheld type device. In the example shown in FIG. 1 the input device 26 is similar to a traditional keyboard that is supported by a support 28. This is just one example of any commonly available input type devices that may from time to time become part of the commonly available art.

Generally, the input device 26 and/or the control panel 30, if included in the device, can control such features as turning the cameras 16, 18 on or off for privacy, changing the orientation or content of various displayed video or audio content, video or audio communication, device settings and other features that may require control or adjustment during use of the device.

The display 32 itself can also preferably be an input device by being able to accept touch inputs from the user of the device. In this manner virtual buttons 36 may be placed in predetermined positions on the display 32. In the example shown in FIG. 2 there are buttons 36 to snap a still image, make a video recording and to initiate sending the images to a remote user.

With the display 32 controllable by touch the insets 34, 40 and others may be moved around the display 32. Additional insets can be created, shown, moved around the screen 32 and closed as desired by the shopper at the swipe of a finger on the display 32.

In an anticipated use of the device a person P is trying on clothes in proximity to the invention. Person P can snap a still image by touching button 36 and the image then appears, for example, in a first inset 34. The person P can then send the image to a friend, who can be seen in a video conference window in a second inset 40. The person P can then temporarily blind the cameras 16, 18 to change clothes and then discuss the choices with the friend in the videoconference in inset 40. The microphone 22 and integrated speakers, cameras 16, 18 and display 32 allow for easy, full featured conversation.

Demonstrating another possible example of functionality is a ticker 38 that can show streaming comments by others, possibly involved on a social network platform. People away from the shopper can thus view and comment on images selected for distribution by the shopper so that the shopper can make an informed and proper decision on the purchase with the help of others.

A processor assembly comprised of a processor, a memory storage device, a means for internet connectivity and other components to support the various features and elements of the device are provided inside the device. Generally, most of the components of an integrated personal computer are present to control and allow the other components to function yet remain adaptable for eventual upgrades in software and hardware components. Preferably there is an access panel to add or remove electronic components for upgrades and repairs as may be needed from time to time.

The device is anticipated to be best used in a location such as near a clothes store dressing room or in a home bedroom. It can be hung on a wall near where clothes are tried on and space can be afforded. The user can turn on the device which initiates the camera(s) 16, 18 and the display 32. A real-time image of the user standing in front of the device is then shown on the display 32. The user has the option to turn on the light 20 and adjust its color tones best suited for the environment.

Once the user is ready to interact with others using the device she can log into predetermined accounts, such as a social networking site, communications site or proprietary site designed for use with the device by the manufacturer of the device. The software has options to selectively allow communication with others and restricts access from others depending on the desire of the user. Some of the buttons and controls may be utilized by means of the touch screen display 32, the control panel 30 (if present) and/or an input device 26 (if present). Voice commands picked up by the microphone 22 may also be available.

The user can then snap still images or capture video sequences. Similar to commonly available image manipulation software the images may be saved, stored, cropped, edited and otherwise changed to be most appropriate for dissemination to friends and colleagues. The cameras 16, 18 and microphone 22 can be easily turned on and off respecting privacy concerns during, for example, changing clothes.

If the user selects, a conversation can be had by video conference with others in a window such as the second inset 40. Other images, perhaps of earlier sampled outfits may be viewed on the display 32 in a box such as the first inset 34. The user may also view previously recorded larger size images at her selection.

Particularly if the device is used in a retail store setting the scanner 24 can be used to capture data relating to the particular article scanned, for example, model number, price and size availability. Other data may be displayed at the direction of the store or owner of the device such as alternate suggestions for complementary pieces or colors.

If appropriately configured, the software may also query the internet for availability at competing retail outlets or for alternate suggested articles of clothing. Sales information, discounts and coupons may also be offered to the shopper.

A shopper may also store a series of images for later review, cataloging and use. For example, maybe the shopper tries on several new garments and then at a later time, or simply from a remote location can review the articles. Similarly, friends can shop together even if they are in different stores in the same mall or across the world.

Of particular interest is the shopper with a shopping-resistant partner. In this case, the shopper can try on clothes and their partner can, from time to time as outfits are presentable, remotely view and comment on the outfits from a comfortable, remote location.

A preferred version of the device can be described as an interactive multi-media shopping aid comprising a frame assembly, a processor assembly and a display assembly. The processor assembly further comprised of several components which generally include at least a memory storage means, an internet connectivity means and a data processor. Said memory storage means adapted to store a data set comprised of any of a variety of digital and analog data such as an audio file, a video file, a still image, a web page, a data file or an combination thereof. The data processor is adapted to access said memory storage to store and retrieve a data set by commonly available computing means. Said data processor is adapted to send and receive a data set over a network by said internet connectivity means over a local intranet or internet as may be adapted from time to time. Said data processor is adapted to deliver a predetermined video content to said display and over said network to a remote device. The video may be live video captured by the camera or other stored multimedia content. Said display having a first surface that is adapted to display said predetermined visual content that may be formatted in a variety of configurations. Said first surface of said display assembly adapted to accept a user's input by touching the first surface of the display, effectively being a touch-screen display. Integrated into said frame assembly is at least one camera, at least one audio microphone, at least one speaker, a scanner and a control panel having at least a power on-off selector but alternatively other control buttons. Said camera is adapted to acquire and deliver to said data processor and store in said memory storage any combination of a still image and a video image for immediate display, retention in memory or transmission over the internet for remote persons viewing the user trying on clothes. The microphone is adapted to acquire and deliver to said data processor and store in said memory storage means an audio file for immediate broadcast over the internet of storage for later transmission or viewing. Said scanner adapted to acquire a predetermined data set from an article of clothing and deliver said data set to said data processor to aid in providing additional information to the shopper. Said predetermined data set comprising identifying information about said article of clothing like a bar code, RFID tag, serial number, model number and the like. Said data processor is adapted to query a remote database with said identifying information and receives a response comprised of a second set of data comprised of, for example, the availability of said article of clothing, suggested accessories, alternate colors, styles or versions of said article of clothing and other similar information that may interest the user of the device. Said data processor adapted to selectively display an inset window onto said first surface of the display that contains, for example, said second data set, a video conference with a remote person, a text communication with a remote person, a recorded video content, a recorded image or any other images of interest to a shopper. It may include television content, social network connections, news and weather feeds or other information. Said predetermined visual content may be comprised of, for example, a real time video acquired by said camera, a recoded video acquired by said camera, said inset window or a file directory of files stored in said memory storage means. Said data processor is adapted to display on said display assembly a real-time video image acquired by said camera and is also adapted to deliver over said network, inter alia, said real-time video, a real-time audio stream, a recorded video file, a recorded video file, said data set or said second data set.

Important variations include a light in the frame directed to illuminate a user in front of said first surface of the display or also including a keypad input device for an alternate means of controlling the device.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An interactive multimedia shopping aid comprising a frame assembly, a processor assembly and a display assembly;
Said processor assembly further comprised of a memory storage means, an internet connectivity means and a data processor;
Said memory storage means adapted to store a data set comprised of any of: an audio file, a video file, a still image, a web page or a data file;
Said data processor adapted to access said memory storage to store and retrieve a data set;
Said data processor adapted to send and receive a data set over a network by said internet connectivity means;
Said data processor adapted to deliver a predetermined video content to said display and over said network to a remote device;
Said display having a first surface that is adapted to display said predetermined visual content;
Said first surface of said display assembly adapted to accept a user's input by touching the first surface of the display;
Integrated into said frame assembly is at least one camera, at least one audio microphone, at least one speaker, a scanner and a control panel;
Said control panel is comprised of at least a power on-off selector;
Said camera adapted to acquire and deliver to said data processor and store in said memory storage any combination of a still image and a video image;
Said microphone adapted to acquire and deliver to said data processor and store in said memory storage means an audio file;
Said scanner adapted to acquire a predetermined data set from an article of clothing and deliver said data set to said data processor;
Said predetermined data set comprising identifying information about said article of clothing;
Said data processor adapted to query a remote database with said identifying information and receives a response comprised of a second set of data comprised of any of: availability of said article of clothing, suggested accessories, alternate colors, styles or versions of said article of clothing;
Said data processor adapted to selectively display an inset window onto said first surface of the display that contains any of:
said second data set, a video conference with a remote person, a text communication with a remote person, a recorded video content or a recorded image;
Said predetermined visual content comprised of any of: a real time video acquired by said camera, a recoded video acquired by said camera, said inset window or a file directory of files stored in said memory storage means;
Said data processor adapted to display on said display assembly a real-time video image acquired by said camera;
Said data processor adapted to deliver over said network any of: said real-time video, a real-time audio stream, a recorded video file, a recorded video file, said data set or said second data set.

2. An interactive multi-media shopping aid as disclosed in claim 1 further characterized in that said frame assembly includes a light directed to illuminate a user in front of said first surface of the display.

3. An interactive multi-media shopping aid as disclosed in claim 2 further characterized in that said frame assembly also includes a keypad input device.
